(19) United States
(12) Patent Application Publication
(10) Pub. No.: US 2023/0214063 A1
(43) Pub. Date: Jul. 6, 2023

(54) INFRARED TOUCHSCREEN FOR ELECTRONIC LOCKS

(71) Applicant: Spectrum Brands, Inc., Middleton, WI (US)

(72) Inventor: Kevin Pasma, Lake Forest, CA (US)

(21) Appl. No.: 18/150,937

(22) Filed: Jan. 6, 2023

Related U.S. Application Data
(60) Provisional application No. 63/297,114, filed on Jan. 6, 2022.

(51) Int. Cl. G06F 3/042

(52) U.S. Cl. CPC G06F 3/0421; G06F 2203/04104

(57) ABSTRACT

Systems and methods are disclosed for a lock assembly having a touchscreen. The lock assembly includes an interior assembly and an exterior assembly having an exterior lock housing and an infrared touchscreen assembly. The infrared touchscreen assembly includes a touch interface and one or more infrared emitter and receiver systems. One aspect is a method of actuating a lock, the method comprising: causing one or more infrared emitters to emit infrared light; detecting the infrared light at one or more infrared receivers; determining a position of an object interacting with a touch interface of an infrared touchscreen based on the one or more infrared receivers detecting the infrared light; determining a value that corresponds to the position; determining that the value corresponds to an actuation command; and actuating a bolt of the lock based on determining the value corresponds to the actuation command.

### CROSS-REFERENCE TO RELATED APPLICATION

This application claims the benefit of U.S. Provisional Application Ser. No. 63/297,114, filed Jan. 6, 2022, the disclosure of which is hereby incorporated by reference in its entirety.

### TECHNICAL FIELD

This disclosure relates to entry/access systems such as electronic locks and in particular, to infrared touchscreens for entry/access systems.

### BACKGROUND

Electronic locks have gained increasing acceptance and widespread use in residential and commercial markets as entry/access systems. These locksets control ingress through doors in a building by requiring certain electronic credentials. For example, these locksets typically include a control circuit that determines whether to unlock the lockset based on credentials provided by the user. In some cases, for example, the credentials and/or commands may be provided through a touch-sensitive surface, such as a touchscreen.

Touchscreen assemblies may operate using physical buttons, resistive screens that utilize electrode films, capacitive screens that utilize electrodes, and/or optical screens that utilize light and optical sensors. Touchscreens that are included on locks are prone to false wakeups due to the environmental conditions the locks. Additionally, depending on the type of touchscreen, the touchscreen may require direct contact to be used.

### SUMMARY

In general, the present disclosure relates to an infrared touchscreen assembly for an electronic lock.

One aspect of the present disclosure is a method of actuating a lock, the method comprising causing one or more infrared emitters to emit infrared light, detecting the infrared light at one or more infrared receivers, determining a position of an object interacting with a touch interface of an infrared touchscreen based on the one or more infrared receivers detecting the infrared light, determining a value that corresponds to the position of the object, determining that the value corresponds to an actuation command; and actuating a bolt of the lock based on determining that the value corresponds to the actuation command.

Another aspect of the present disclosure is a computer readable storage medium comprising instructions which, when executed by a processor, cause the processor to cause one or more infrared emitters to emit infrared light, detect the infrared light at one or more infrared receivers, determine one or more positions of an object interacting with a touch interface of an infrared touchscreen based on the one or more infrared receivers detecting the reflected infrared light, determine one or more values that correspond to the one or more positions, determine that the one or more values correspond to an actuation command, and actuate a bolt of a lock based on determining that the one or more values correspond to the actuation command.

Yet another aspect of the present disclosure is an electronic lock comprising an infrared touchscreen comprising, a touch interface, one or more infrared emitters, and one or more infrared receivers, a latch assembly comprising a bolt; and a processing unit comprising a processor and a memory storing instructions which, when executed by the processor, cause the processor to cause at least a portion of the one or more infrared emitters to emit infrared light, detect the infrared light at the one or more infrared receivers, determine one or more positions of an object interacting with the touch interface based on the one or more infrared receivers detecting the infrared light, determine one or more values that correspond to the one or more positions, determine that the one or more values correspond to one of one or more actuation commands, and actuate the bolt based on determining that the one or more values correspond to one of the one or more actuation commands.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 illustrates an example infrared touchscreen, in accordance with some embodiments of the present disclosure.

FIG. 2 illustrates an object interacting with the infrared touchscreen of FIG. 1, in accordance with some embodiments of the present disclosure.

FIG. 3 illustrates a perspective view of an electronic lock with an infrared touchscreen, in accordance with some embodiments of the present disclosure.

FIG. 4 is a rear perspective view of a portion of the electronic lock seen in the environment of FIG. 4, in accordance with some embodiments of the present disclosure.

FIG. 5 illustrates a front perspective view of a portion of the electronic lock seen in the environment of FIG. 4, in accordance with some embodiments of the present disclosure.

FIG. 6 illustrates a schematic representation of the electronic lock seen in the environment of FIG. 4, in accordance with some embodiments of the present disclosure.

FIG. 7 illustrates a flowchart of a method of receiving an input via an infrared touchscreen to actuate a lock, in accordance with some embodiments of the present disclosure.

### DETAILED DESCRIPTION

Various examples of the present disclosure will be described in detail with reference to the drawings, wherein like reference numerals represent like parts and assemblies throughout the several views. Reference to various examples does not limit the scope of the disclosure, which is limited only by the scope of the claims attached hereto. Additionally, any examples set forth in this specification are not intended to be limiting and merely set forth some of the many possible examples for the claimed disclosure.

As briefly described above, examples of the present disclosure are directed to an infrared touchscreen for access/entry systems such as electronic locks. The infrared touchscreen includes a touch interface and one or more infrared emitter and receiver systems. The infrared emitter and receiver systems include an infrared emitter that emits light across the touchscreen. The infrared emitter and receiver systems also include an infrared receiver that receives the infrared light emitted by the infrared emitter. The infrared emitter and receiver systems can identify the location of an object, such as a finger, touching or in close proximity to the touchscreen due to the object interrupting the path of the emitted infrared light, causing the infrared light to reflect off the object and/or blocking the path of the emitted infrared light, and the infrared receiver systems receiving the infrared light reflected off the object and/or not receiving the emitted infrared light due to the object blocking the path of the emitted infrared light.

The touchscreen assembly described herein improves the overall functionality of the touchscreen relative to conventional touchscreens (e.g., in particular, electronic lock touchscreens). As described further herein, the touchscreen assembly includes infrared emitter and receiver systems that allow the touchscreen to register interaction with the touchscreen further away from the touchscreen, preserves energy by preventing false wakeups, and allows for different decorative designs (e.g., arrangement of buttons, labels on the buttons, etc.) of the touchscreen without requiring modification of the functional design of the touchscreen (e.g., location of the infrared emitter and receiver systems).

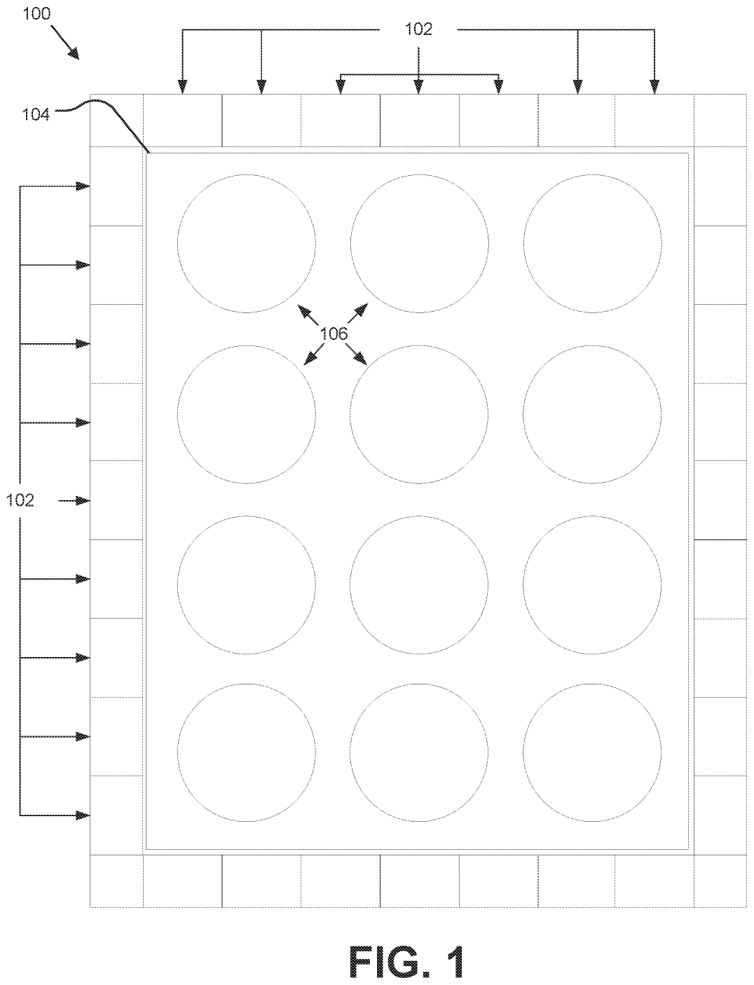

FIG. 1 shows an example infrared touchscreen 100. In this example, the infrared touchscreen 100 includes a plurality of infrared emitter and receiver systems 102 arranged around the perimeter of the infrared touchscreen 100. The infrared touchscreen 100 also includes a touch interface 104 and a plurality of buttons 106 positioned on the touch interface 104.

In examples, the infrared emitter and receiver systems 102 include an infrared emitter and an infrared receiver. The infrared emitter emits infrared light, and the infrared receiver detects when infrared light is received at the infrared receiver's location. The infrared emitter and receiver systems 102 can identify a position on the touch interface 104 that is interacted with as a result of the infrared emitters emitting infrared light and the infrared receivers detecting whether infrared light is received. In some examples, the infrared emitters and the infrared receivers of the infrared emitter and receiver systems 102 may be positioned in different locations. The infrared emitters and the infrared receivers can be positioned in any configuration to ensure that the position of an object interacting with the touch interface 104 can be accurately determined.

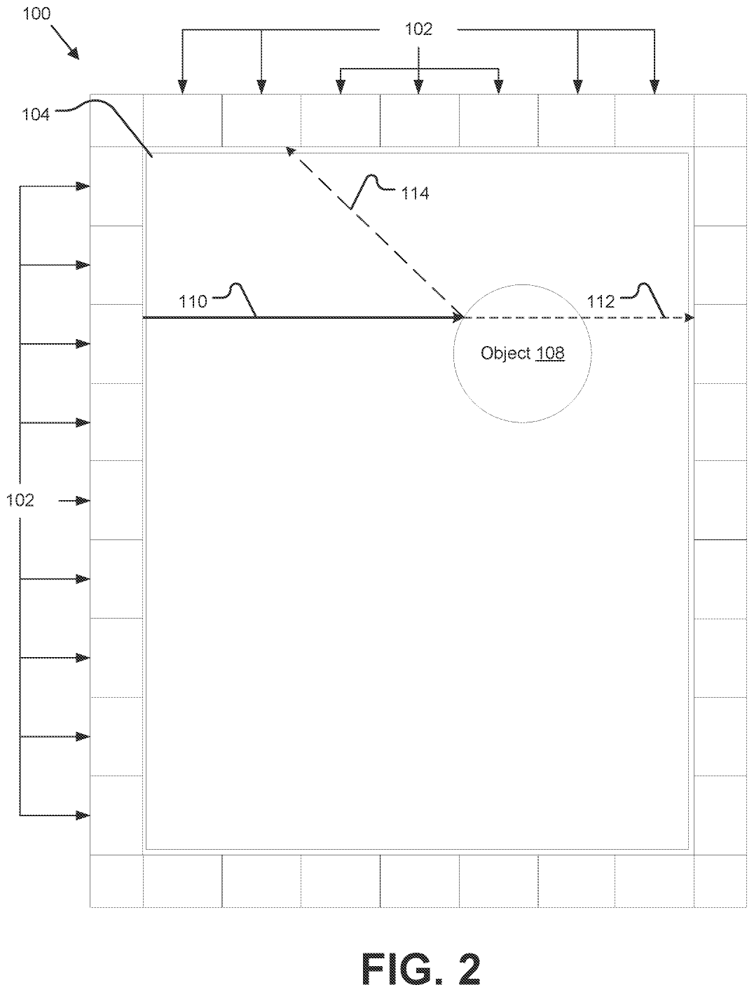

In examples, the infrared emitter and receiver systems 102 operate simultaneously and all emit and/or receive infrared light. In other examples, the infrared emitter and receiver systems 102 operate separately. For example, only the infrared emitter and receiver systems 102 on the left and/or right side of the infrared touchscreen 100 may emit infrared light for a time period, and all the infrared emitter and receiver systems 102 may detect where the emitted infrared light is received. In a subsequent time period, only the infrared emitter and receiver systems 102 on the top and/or bottom side of the infrared touchscreen 100 may emit infrared light for a time period, and all the infrared emitter and receiver systems 102 may detect where the emitted infrared light is received. The operation of the infrared emitter and receiver systems 102 can be altered to effectively determine the position of an object that interacts with the touch interface 104. This position identification process will be explained in more detail herein with respect to FIG. 2.

In examples, the buttons 106 include decorative markings that indicate a position a user should interact with on the touch interface 104 to input a value. For example, the buttons 106 may have a numerical value that indicates the value a user will input when interacting with the touch interface at the location of the button 106. In some examples, the buttons 106 may include physical characteristics such as a raised edge, a recessed edge, and/or any other physical characteristic that identifies a location of the touch interface 104 without impeding the operation of the infrared emitter and receiver systems 102.

In examples, the buttons 106 are not mechanical buttons. The buttons 106 are markings or other indications of a position of the touch interface 104 that should be interacted with to input a value.

Other configurations of the infrared touchscreen 100 are contemplated. In examples, the infrared emitter and receiver systems 102 are positioned underneath the touch interface 104. The infrared emitters are operable to emit infrared light through the touch interface 104, and the infrared receivers are operable to detect infrared light received through the touch interface 104. An alternative configuration may allow the infrared touchscreen 100 to detect an object interacting with the touch interface 104 farther from the touch interface 104. In other examples, the infrared emitter and receiver systems 102 are positioned around the perimeter of the touch interface 104 and underneath the touch interface 104. In these examples, the positions of the infrared emitter and receiver systems 102 may increase the accuracy of determining the position of the object interacting with the touch interface 104.

FIG. 2 illustrates an object 108 interacting with the infrared touchscreen 100 of FIG. 1. In this example, the infrared touchscreen 100 includes a plurality of infrared emitter and receiver systems 102 arranged around the perimeter of the infrared touchscreen 100, a touch interface 104, and an object 108 interacting with a position of the touch interface 104. Additionally, the infrared touchscreen 100 includes a beam of infrared light 110 emitted by one of the infrared emitter and receiver systems 102, the original trajectory of the beam of infrared light 112, and the reflected beam of infrared light 114. In some examples, a single infrared emitter and receiver system 102 is emitting a single beam of infrared light 110. However, any number of infrared emitter and receiver systems 102 may be emitting and/or receiving infrared light simultaneously.

In this illustrated example, an infrared emitter and receiver system 102 on the left side of the infrared touchscreen 100 is emitting a beam of infrared light 110. If an object was not interacting with the touch interface 104, the beam of infrared light 110 would continue on the original trajectory of the beam of infrared light 112. In this example, the infrared receiver of the infrared emitter and receiver system 102 on the right side of the infrared emitter and receiver system 102 emitting the beam of infrared light 110 would detect that infrared light is being received, as indicated by the original trajectory of the beam of infrared light 112.

In examples, the reflected beam of infrared light 114 is not used to determine the location of the object. For example, the beam of infrared light 110 not continuing on the original trajectory of the beam of infrared light 112 causes the infrared emitter and receiver system 102 on the right side of the infrared touchscreen to detect no infrared light. The absence of infrared light detected by the infrared receiver of the infrared emitter and receiver system 102 on the right side of the infrared touchscreen indicates that there is an object, such as object 108, in a position between the infrared emitter and receiver system 102 emitting the light and the infrared emitter and receiver system 102 on the right side of the infrared touchscreen 100.

In the illustrated example, the path of the beam of infrared light 110 is interrupted by the object 108 and the beam of light is reflected by the object, resulting in the reflected beam of infrared light 114. The infrared emitter and receiver system 102 at the top of the infrared touchscreen 100 will detect received infrared light as a result of the reflected beam of infrared light 114. In examples, the infrared touchscreen 100 can determine the position of the object 108 on the touch interface 104 by determining which infrared emitter and receiver system 102 at the top of the infrared touchscreen 100 detects the reflected beam of infrared light 114. In examples, multiple beams of infrared light are emitted and/or received to better determine the position of the object 108.

In some examples, the position of the object 108 on the touch interface 104 may change. This change in position will cause different infrared emitter and receiver systems 102 to detect received infrared light. The infrared touchscreen 100 can detect the movement of the object 108 and determine that the object 108 selects more than one button such as the buttons 106 shown in FIG. 1.

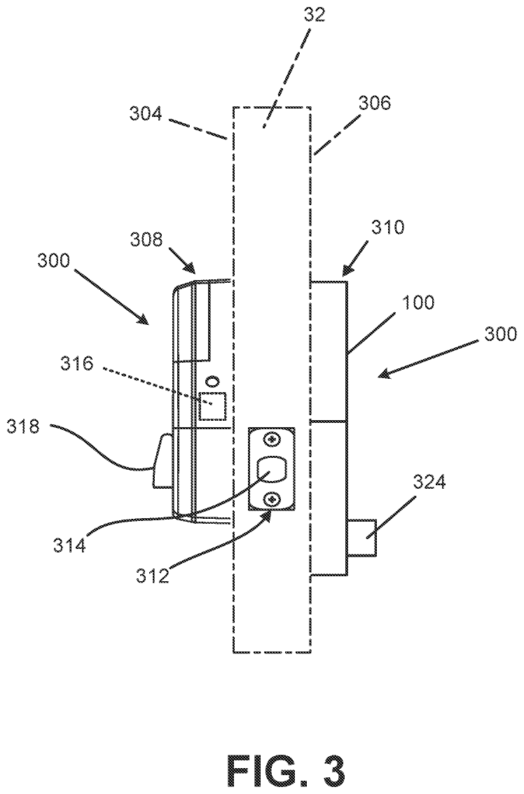

FIGS. 3-5 illustrate an example electronic lock 300 installed at a door 32. The door 32 has an interior side 304 and an exterior side 306. The electronic lock 300 includes an interior assembly 308, an exterior assembly 310, and a latch assembly 312. The latch assembly 312 is shown to include a bolt 314 that is movable between an extended position (locked) and a retracted position (unlocked, shown in FIGS. 3-5). Specifically, the bolt 314 is configured to slide longitudinally and, when the bolt 314 is retracted, the door 32 is in an unlocked state. When the bolt 314 is extended, the bolt 314 protrudes from the door 32 into a doorjamb (not shown) to place the door in a locked state.

In some examples, the interior assembly 308 is mounted to the interior side 304 of the door 32, and the exterior assembly 310 is mounted to the exterior side 306 of the door 32. The latch assembly 312 is typically at least partially mounted in a bore formed in the door 32. The term “outside” is broadly used to mean an area outside the door 32 and “inside” is broadly used to denote an area inside the door 32. With an exterior entry door, for example, the exterior assembly 310 may be mounted outside a building, while the interior assembly 308 may be mounted inside a building. With an interior door, the exterior assembly 310 may be mounted inside a building, but outside a room secured by the electronic lock 300, and the interior assembly 308 may be mounted inside the secured room. The electronic lock 300 is applicable to both interior and exterior doors. It should be noted that a lock assembly 10 may be used on other types of doors, such as a garage door or a doggie door, or other types of doors that may be used with an infrared touchscreen such as infrared touchscreen 100 illustrated in FIGS. 1-2. In the example shown, the electronic lock 300 is in the form of a deadbolt. However, this disclosure is not intended to be limited to only an electronic deadbolt, but instead encompasses any kind of lock (e.g., cabinet lock, padlock, locker lock, lever, knob).

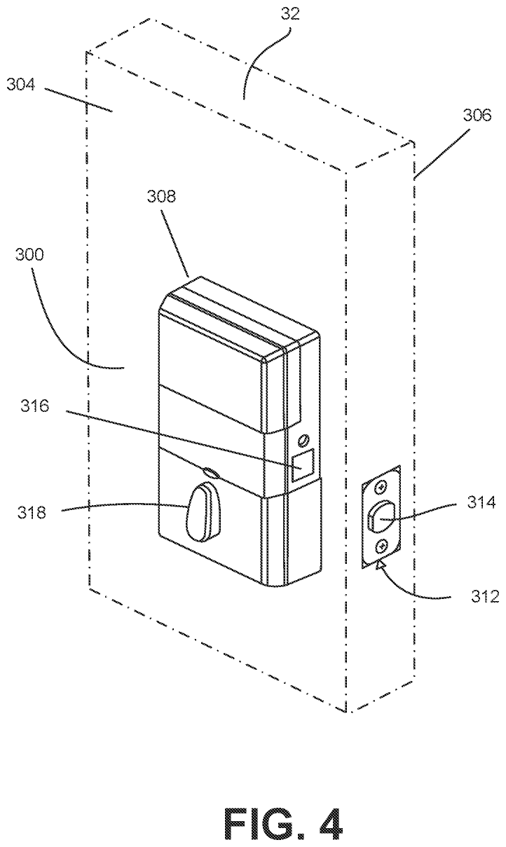

Referring to FIG. 4, the interior assembly 308 can include a processing unit 316 (shown schematically) containing electronic circuitry for the electronic lock 300. The processing unit 316 is operable to execute a plurality of software instructions (i.e., firmware) that, when executed by the processing unit 316, cause the electronic lock 300 to implement the methods and otherwise operate and have functionality as described herein. For example, the processing unit 316 may execute software instructions that cause the infrared touchscreen 100 shown in FIGS. 1-2 to operate. The processing unit 316 may comprise a device commonly referred to as a processor, e.g., a central processing unit (CPU), digital signal processor (DSP), or other similar device, and may be embodied as a standalone unit or as a device shared with components of the electronic lock 300. The processing unit 316 may include a computer readable storage medium, also referred to as a memory, communicatively interfaced to the processor, for storing the software instructions. Alternatively, the electronic lock 300 may further comprise a separate memory device for storing the software instructions that is electrically connected to the processing unit 316 for the bi-directional communication of the instructions, data, and signals therebetween.

In some examples, the interior assembly 308 includes a manual turn piece 318 that can be used on the interior side 304 of door 32 to move the bolt 314 between the extended and retracted positions.

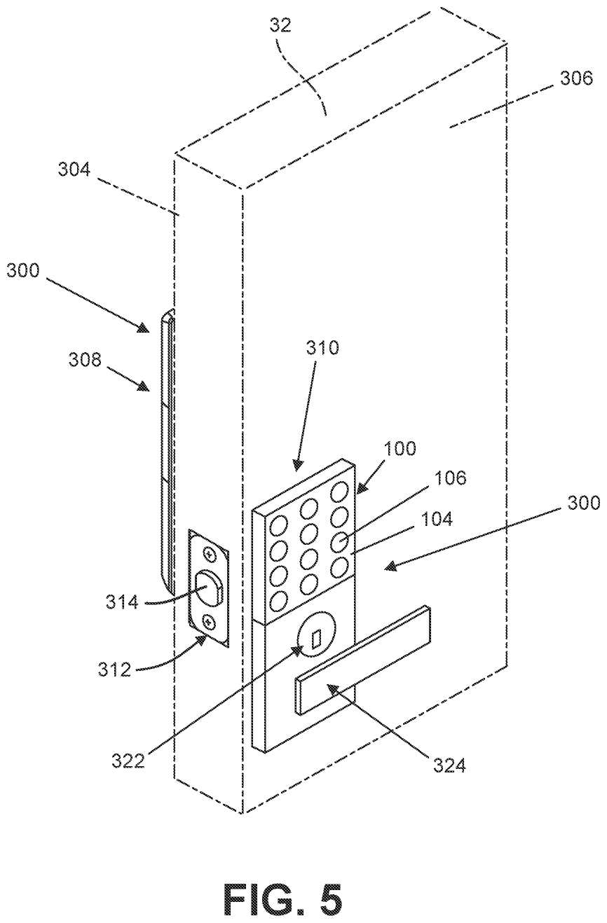

Referring to FIG. 5, the exterior assembly 310 can include exterior circuitry communicatively and electrically connected to the processing unit 316. For example, the exterior assembly 310 can include an infrared touchscreen 100, shown in FIGS. 1-2, for receiving a user input and/or a keyway 322 for receiving a key (not shown). The exterior side 306 of the door 32 can also include a handle 324. In other examples, the exterior assembly 310 includes the infrared touchscreen 100 and not the keyway 322. When a valid key is inserted into the keyway 322, the valid key can move the bolt 314 between the extended and retracted positions. When a user inputs a valid actuation passcode into the infrared touchscreen 100, the bolt 314 is moved between the extended and retracted positions. For example, a user must input a sequence of values by interacting with the infrared touchscreen 100 at positions on the touch interface 104 indicated by the buttons 106. In some examples, the exterior assembly 310 is electrically connected to the interior assembly 308. Specifically, the infrared touchscreen 100 is electrically connected to the interior assembly 308, specifically to the processing unit 316, by, for example, an electrical cable (not shown) that passes through the door 32. When the user inputs a valid actuation passcode via the infrared touchscreen 100 that is recognized by the processing unit 316, an electrical motor is energized to retract the bolt 314 of latch assembly 312, thus permitting door 32 to be opened from a closed position. Further, an electrical connection between the exterior assembly 310 and the interior assembly 308 allows the processing unit 316 to communicate with other features included in the exterior assembly 310, as noted below.

The touch interface 104 and/or the buttons 106 of the infrared touchscreen 100 can include markings or other indications of positions a user should interact with to select a value. The touch interface and/or the buttons 106 can include numeric markings, alpha markings, alphanumeric markings, and/or other indications that equate positions on the touch interface 104 to a value. For example, the button 106 in the top left portion of the touch interface 104 may include a marking of the number one. Thus, the button 106 in the top left portion indicates to a user that interacting with the touch interface 104 in the top left portion will input a value of one. The infrared touchscreen 100 can have any number of markings or indications, such as the buttons 106.

In some examples, the infrared touchscreen 100 includes the touch interface 104 for receiving a user input. The infrared touchscreen 100 detects a user's “press of a button” by contact without the need for pressure or mechanical actuation. For example, the infrared touch interface can receive inputs via the infrared emitters and receivers.

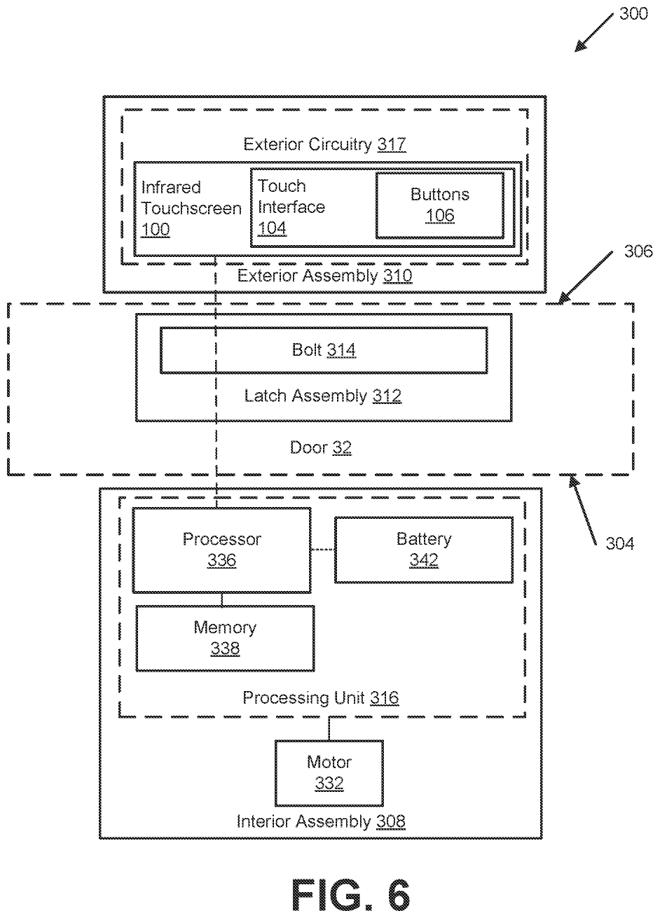

FIG. 6 is a schematic representation of the electronic lock 300 mounted to the door 32. The interior assembly 308, the exterior assembly 310, and the latch assembly 312 are shown.

The exterior assembly 310 is shown to include exterior circuitry 317 including the infrared touchscreen 100, touch interface 104, and buttons 106. In response to input received by the infrared touchscreen 100, the processor unit 316 may execute software instructions to open or close the bolt 314. As described above, the interior assembly 308 includes the processing unit 316. The interior assembly 308 can also include a motor 332.

As shown, the processing unit 316 includes at least one processor 336 communicatively connected to a memory 338 and a battery 342. The processing unit 316 is located within the interior assembly 308 and is capable of operating the electronic lock 300, e.g., by actuating the motor 332 to actuate the bolt 314.

In some examples, the at least one processor 336 can process input received from the infrared touchscreen 100 to determine whether the electronic lock 300 should be actuated. Such processing can be based on a set of preprogramed instructions (i.e., firmware) stored in the memory 338. In certain embodiments, the processing unit 316 can include a plurality of processors 336, including one or more general purpose or specific purpose instruction processors. In some examples, the processing unit 316 is configured to capture a keypad input event from a user via the infrared touchscreen 100 and store the keypad input event in the memory 338.

The memory 338 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices. Computer storage media can, in some examples, include embodiments including entirely non-transitory components.

The interior assembly 308 also includes the battery 342 to power the electronic lock 300. In one example, the battery 342 may be a standard single-use (disposable) battery. Alternatively, the battery 342 may be rechargeable. In still further embodiments, the battery 342 is optional altogether, replaced by an alternative power source (e.g., an AC power connection).

The interior assembly 308 also includes the motor 332 that is capable of actuating the bolt 314. In use, the motor 332 receives an actuation command from the processing unit 316, which causes the motor 132 to actuate the bolt 314 from the locked position to the unlocked position or from the unlocked position to the locked position. In some examples, the motor 332 actuates the bolt 314 to an opposing state. In some examples, the motor 332 receives a specified lock or unlock command, where the motor 332 only actuates the bolt 314 if the bolt 314 is in the correct position. For example, if the door 32 is locked and the motor 332 receives a lock command, then no action is taken. If the door 32 is locked and the motor 332 receives an unlock command, then the motor 332 actuates the bolt 314 to unlock the door 32. In other examples, a manual turn piece 308 is included in the exterior assembly that a user can turn after inputting a valid actuation command via the infrared touchscreen 100. In examples, a valid actuation command is one or more values input via the infrared touchscreen 100. The values may be required to be input in a specific sequence to correspond to an actuation command. The actuation command(s) may be stored in memory 338 for the at least one processor 336 to determine whether the input value(s) correspond to a valid actuation command.

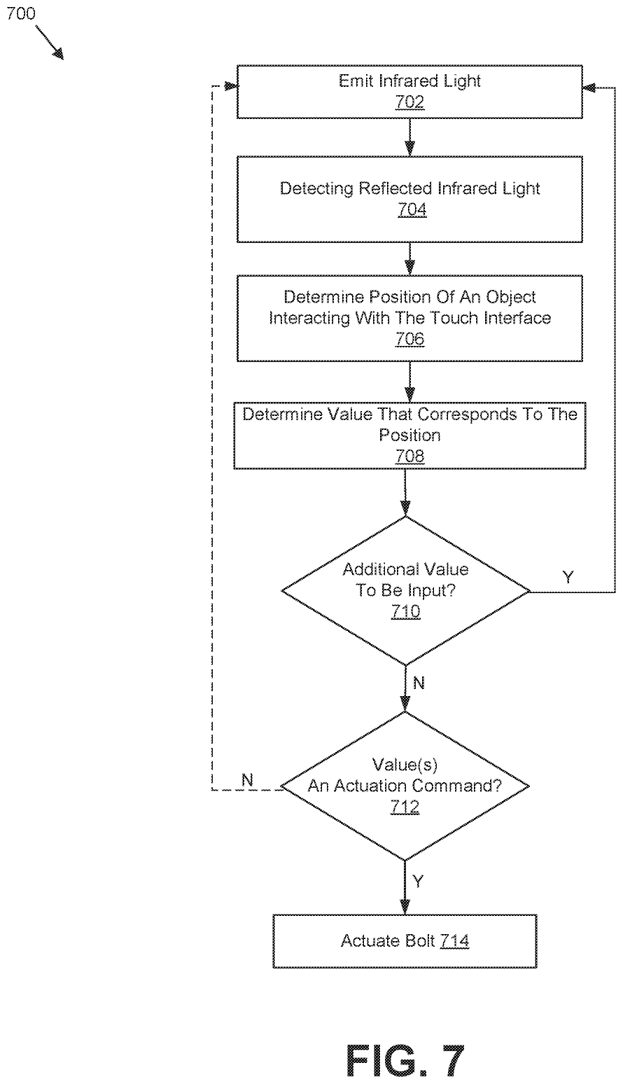

FIG. 7 illustrates a flowchart of a method 700 of receiving an input via an infrared touchscreen to actuate a lock. Method 700 includes operations 702, 704, 706, 708, 710, 712, and 714.

Beginning in operation 702, infrared light is emitted. For example, the processing unit 316 causes one or more infrared emitter and receiver systems 102 to emit light across the touch interface 104 of the infrared touchscreen 100 shown in FIG. 1. The number of infrared emitter and receiver systems 102 that emit light may be any number sufficient to detect an object interacting with the touch interface 104.

In examples, the infrared touchscreen 100 stays in a low power mode and infrared light is not emitted or a minimum number of infrared emitter and receiver systems 102 emit infrared light until the processing unit 316 determines that a user wishes to input values. For example, a user may interact with the infrared touchscreen 100 to cause the infrared touchscreen 100 to exit the low power mode before attempting to input a value. In some examples, a minimum number of infrared emitter and receiver systems 102 emit infrared light to determine whether an object interacts with the infrared touchscreen 100 before the infrared touchscreen 100 will exit the low power mode. The operation of the minimum number of infrared emitter and receiver systems 102 emitting infrared light prevents false wakeups from environmental conditions such as changing sunlight, shadows, motion, and so on. In this example, an object must interact with the infrared touchscreen 100 before the infrared touchscreen 100 will exit the low power mode.

In some examples, the infrared touchscreen 100 may enter the low power mode after the lock is successfully actuated. Additionally, the infrared touchscreen 100 may enter a low power mode after a time period that an object does not interact with the touch interface 104. For example, the infrared touchscreen 100 may enter the low power mode when no object is detected for five seconds.

The operation 704 detects reflected infrared light at one or more infrared receivers. In some embodiments, once infrared light is emitted, it is determined which infrared receivers detect the infrared light which is reflected (e.g., by an object). For example, one or more of the infrared emitter and receiver systems 102 may detect that infrared light is received, and the processing unit 316 may determine or otherwise identify which infrared emitter and receiver systems 102 detect the received infrared light.

The operation 706 determines a position of an object interacting with a touch interface. In some embodiments, the position is determined based on the one or more infrared receivers detecting the reflected infrared light. For example, the processing unit 316 shown in FIG. 6 may determine the position of an object, such as a finger, based on which infrared emitter and receiver systems 102 emitted and/or received infrared light. The processing unit 316 can determine the position of the object based on which infrared emitter and receiver systems 102 emitted and/or received infrared light by determining the difference between which infrared emitter and receiver systems 102 were expected to detect received infrared light, such as the infrared and receiver system 102 that would receive light based on the original trajectory of the beam of infrared light 112 shown in FIG. 2, and which infrared emitter and receiver systems 102 actually received infrared light.

In examples, the object does not need to physically contact the touch interface 104 for the position of the object to be determined. The beams of infrared light are emitted across the touch interface 104, but the beams are not required to be emitted at the same level as the surface of the touch interface. Thus, the object may just need to be close enough to interrupt or otherwise contact the emitted beams of infrared light.

In operation 708, a value that corresponds to the position of the object is determined. For example, the processing unit 316 determines the value that corresponds to the position of the object on the touch interface 104. In examples, the processing unit 316 stores the value that corresponds to the position of the object in the memory 338. In examples, the touch interface 104 includes buttons 106 that indicate the value that corresponds to the position each button 106 is located on the touch interface 104.

In operation 710, it is determined whether an additional value should be input. For example, the processing unit 316 determines that an additional value is required to be input before the bolt of the lock is actuated. In examples, the processing unit 316 requires a sequence of values to be input before the bolt of the lock is actuated. For example, the processing unit 316 may require a sequence of four values input in a required order before the bolt is actuated. The processing unit 316 may store multiple sequences that can be input by a user, installed by a manufacturer, and/or otherwise saved to the memory 338. Additionally, the processing unit 316 may include temporary sequences in the memory 338 that work for a single use or other finite number of uses.

In examples, it is determined whether an additional value is to be input based on whether an ending value is input. For example, the bottom right portion of the screen may correspond to the ending value, and the processing unit 316 determines that an additional value should be input until the ending value is selected. In other examples, the processing unit 316 requires a set number of values before continuing to operations 712 and 714. For example, the processing unit may require a total of six values to be input before determining that an additional value does not need to be input.

If it is determined that an additional value should be input in operation 710, flow proceeds back to operation 702. A user of the infrared touchscreen 100 may then input an additional value by placing an object at a position on the touch interface 104 that indicates the value the user wishes to input. The object may be at the same position it was previously or at another position on the touch interface 104. In examples, the processing unit 316 does not proceed with determining the position of the object interacting with the touch interface 104 in operation 706 until the object stops interacting with the touch interface 104 and then subsequently interacts with the touch interface 104 again. For example, a user of the infrared touchscreen 100 inputting values with his or her finger will be required to remove their finger from the touch interface 104 and subsequently position their finger on the touch interface 104 to input an additional value. The processing unit 316 may require removal of the object to prevent unwanted or otherwise accidental input from being determined. If the object is moved to another position on the touch interface 104, the object may not be required to be removed. In other examples, the processing unit 316 may delay determining the position of an object interacting with the touch interface 104 for a period, such as one second, to prevent unwanted or otherwise accidental input from being determined. If the object is moved to another position, the delay may be skipped by the processing unit 316.

If it is determined that an additional value does not need to be input in operation 710, flow proceeds to operation 712. In operation 712, it is determined whether the one or more values that are determined in operation 708 correspond to an actuation command. For example, the at least one processor 336 of processing unit 316 compares the input one or more values determined in operation 708 with one or more actuation commands stored in the memory 338. If the input value(s) do not correspond to an actuation command, method 700 may end or optionally return to operation 702 to allow a user to input new values.

In some examples, actuation commands may only be valid for locking or unlocking the bolt 314. In these examples, when the bolt 314 is currently in the locked position and the one or more values correspond to an actuation command that is only valid for locking the door, the value(s) will be determined to not correspond to a valid actuation command. The bolt 314 is already in the locked position, so flow does not need to proceed to operation 714. In other examples, when the bolt 314 is currently in the unlocked position and the one or more values correspond to an actuation command that is only valid for unlocking the door, the value(s) will be determined to not correspond to a valid actuation command. The bolt 314 is already in the unlocked position, so flow does not need to proceed to operation 714.

If the one or more values determined in operation 708 are determined to correspond to an actuation command in operation 712, flow proceeds to operation 714. In operation 714, the bolt is actuated. For example, the bolt 314 of the electronic lock 300 is actuated. In examples, the bolt 314 is actuated by the motor 332. In other examples, the lock includes a manual turn piece on the exterior side 306 of the door, such as the manual turn piece 318 shown on the interior side 304 of the door. In operation 714, the processing unit 316 can activate or otherwise allow the manual turn piece located on the exterior side 306 of the door to operate and actuate the bolt 314 when a user turns the manual turn piece.

Referring to the above process generally, it is noted that certain aspects may be performed in different orders. Additionally, while the above lock actuation process is described as being performed by a processing unit 316 that is part of the electronic lock 300, it is recognized that other configurations may be used as well. For example, the processing unit 316 may be separate from the electronic lock 300 and communicate with the electronic lock 300 using wired and/or wireless communication techniques.

Aspects of the present description may also be described by the embodiments that follow. The features or combination of features disclosed in the following discussion may also be included in any of the other embodiments disclosed elsewhere herein.

Embodiment 1 is a method of actuating a lock, the method comprising: causing one or more infrared emitters to emit infrared light; determining one or more infrared receivers detect received infrared light; determining a position of an object interacting with a touch interface of an infrared touchscreen based on the one or more infrared receivers detecting received infrared light; determining a value that corresponds to the position; determining that the value corresponds to an actuation command; and actuating a bolt of the lock based on determining the value corresponds to the actuation command.

Embodiment 2 is the method of embodiment 1, further comprising: after determining the position of the object: determining an additional position of the object interacting with the touch interface; determining an additional value that corresponds to the position; determining that a sequence comprising the value and the additional value corresponds to an additional actuation command; and actuating the bolt of the lock based on the sequence corresponding to the additional actuation command.

Embodiment 3 is the method of embodiment 2, wherein the sequence is determined to correspond to the actuation command only when the value and the additional value are determined in a required order.

Embodiment 4 is a computer readable storage medium comprising instructions which, when executed by a processor, cause the processor to: cause one or more infrared emitters to emit infrared light; determine that one or more infrared receivers detect received infrared light; determine one or more positions of an object interacting with a touch interface of an infrared touchscreen based on the one or more infrared receivers detecting received infrared light; determine one or more values that correspond to the one or more positions; determine that the one or more values correspond to an actuation command; and actuate a bolt of a lock based on determining the one or more values correspond to the actuation command.

Embodiment 5 is an electronic lock comprising: an infrared touchscreen comprising: a touch interface, one or more infrared emitters, and one or more infrared receivers; a latch assembly comprising a bolt; and a processing unit comprising: a processor, a memory storing instructions which, when executed by the processor, cause the processor to: cause at least a portion of the one or more infrared emitters to emit infrared light, determine which of the one or more infrared receivers detect received infrared light, determine one or more positions of an object interacting with the touch interface based on the one or more infrared receivers detecting received infrared light, determine one or more values that correspond to the one or more positions, determine that the one or more values correspond to one of one or more actuation commands, and actuate the bolt based on determining the one or more values correspond to one of the one or more actuation commands.

Embodiment 6 is the electronic lock of embodiment 5, further comprising a motor operable to actuate the bolt.

Embodiment 7 is the electronic lock of any embodiments 5 and 6, wherein the infrared touchscreen is operable to enter a low power mode.

Embodiment 8 is the electronic lock of embodiment 7, wherein the memory stores additional instructions which, when executed by the processor and when the infrared touchscreen is in the low power mode, cause the processor to: cause a minimum portion of the one or more infrared emitters to emit infrared light; determine which of the one or more infrared receivers detect received infrared light; determine when the object interacts with the touch interface; and cause the infrared touchscreen to exit the low power mode based on determining when the object interacts with the touch interface.

Embodiment 9 is the electronic lock of any embodiments 5-8, wherein the infrared touchscreen further comprises one or more buttons attached to the touch interface that indicate the value corresponding to a button position for a position of each button on the touch interface.

Embodiment 10 is the electronic lock of any embodiments 5-9, further comprising a battery operable to supply power to the infrared touchscreen and the processing unit.

Embodiment 11 is the electronic lock of embodiment 9, wherein the memory stores the one or more actuation commands.

Embodiment 12 is a method of actuating a lock, the method comprising: causing one or more infrared emitters to emit infrared light; detecting reflected infrared light at one or more infrared receivers; determining a position of an object interacting with a touch interface of an infrared touchscreen based on the one or more infrared receivers detecting the reflected infrared light; determining a value that corresponds to the position; determining that the value corresponds to an actuation command; and actuating a bolt of the lock based on determining that the value corresponds to the actuation command.

Embodiment 13 is the method of embodiment 12, further comprising: after determining the position of the object: determining an additional position of the object interacting with the touch interface; determining an additional value that corresponds to the position; determining that a sequence comprising the value and the additional value corresponds to an additional actuation command; and actuating the bolt of the lock based on the sequence corresponding to the additional actuation command.

Embodiment 14 is the method of embodiment 13, wherein the sequence is determined to correspond to the actuation command only when the value and the additional value are determined in a required order.

Embodiment 15 is the method of any embodiments 12-14, wherein the determining of the position of the object is based on the object interrupting at least one beam of the emitted infrared light, and the one or more infrared receivers detecting at least one reflected beam of the emitted infrared light.

Embodiment 16 is the method of any embodiments 12-15, wherein the one or more infrared emitters are operated simultaneously when determining the position of the object.

Embodiment 17 is the method of any embodiments 12-16, wherein the one or more infrared emitters are operated separately when determining the position of the object.

Embodiment 18 is a computer readable storage medium comprising instructions which, when executed by a processor, cause the processor to: cause one or more infrared emitters to emit infrared light; detect reflected infrared light at one or more infrared receivers; determine one or more positions of an object interacting with a touch interface of an infrared touchscreen based on the one or more infrared receivers detecting the reflected infrared light; determine one or more values that correspond to the one or more positions; determine that the one or more values correspond to an actuation command; and actuate a bolt of a lock based on determining the one or more values correspond to the actuation command.

Embodiment 19 is an electronic lock comprising: an infrared touchscreen comprising: a touch interface, one or more infrared emitters, and one or more infrared receivers; a latch assembly comprising a bolt; and a processing unit comprising: a processor, and a memory storing instructions which, when executed by the processor, cause the processor to: cause at least a portion of the one or more infrared emitters to emit infrared light, detect reflected infrared light at the one or more infrared receivers, determine one or more positions of an object interacting with the touch interface based on the one or more infrared receivers detecting the reflected infrared light, determine one or more values that correspond to the one or more positions, determine that the one or more values correspond to one of one or more actuation commands, and actuate the bolt based on determining the one or more values correspond to one of the one or more actuation commands.

Embodiment 20 is the electronic lock of embodiment 19, further comprising a motor operable to actuate the bolt.

Embodiment 21 is the electronic lock of any embodiments 19 and 20, wherein the infrared touchscreen is operable to enter a low power mode.

Embodiment 22 is the electronic lock of embodiment 21, wherein the memory stores additional instructions which, when executed by the processor and the infrared touchscreen is in the low power mode, cause the processor to: cause a minimum portion of the one or more infrared emitters to emit infrared light; determine which of the one or more infrared receivers detect received infrared light; determine when the object interacts with the touch interface; and cause the infrared touchscreen to exit the low power mode based on determining when the object interacts with the touch interface.

Embodiment 23 is the electronic lock of any embodiments 19-22, wherein the infrared touchscreen further comprises one or more buttons attached to the touch interface that indicate the value corresponding to a button position for a position of each button on the touch interface.

Embodiment 24 is the electronic lock of embodiment 23, wherein the memory stores the one or more actuation commands.

Embodiment 25 is the electronic lock of any embodiments 19-24, further comprising a battery operable to supply power to the infrared touchscreen and the processing unit.

Embodiment 26 is the electronic lock of any embodiments 19-25, wherein the infrared touchscreen enters the low power mode when no object is detected for a duration of time.

Embodiment 27 is the electronic lock of any embodiments 19-26, wherein the one or more infrared emitters are positioned on a separate plane from the touch interface.

Embodiment 28 is the electronic lock of embodiment 27, wherein the one or more positions of the object may be detected by the one or more infrared emitters distanced from a surface of the touch interface.

Embodiment 29 is the electronic lock of any embodiments 19-28, wherein the processing unit may be separate from the electronic lock.

Embodiment 30 is the electronic lock of any embodiments 19-28, wherein the processing unit is configured to delay determining the position of the object interacting with the touch interface.

Embodiment 31 is the electronic lock of embodiment 30, wherein the processing unit is further configured to delay determining the position of the object for approximately one second.

Embodiment 32 is the electronic lock of embodiment 31, wherein the processing unit is further configured to skip the delay if the object is detected at a second position.

Embodiment 33 is the electronic lock of any embodiments 19-32, wherein the processing unit communicates through wireless techniques.

Embodiment 34 is the electronic lock of any embodiments 19-32, wherein the processing unit communicates through wired techniques.

Embodiment 35 is the electronic lock of any embodiments 19-34, further comprising an interior assembly and a manual turn piece.

Embodiment 36 is the electronic lock of any embodiments 19-35, further comprising an exterior assembly and a keyway.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of actuating a lock, the method comprising:
causing one or more infrared emitters to emit infrared light;
detecting the infrared light at one or more infrared receivers;
determining a position of an object interacting with a touch interface of an infrared touchscreen based on the one or more infrared receivers detecting the infrared light;
determining a value that corresponds to the position of the object;
determining that the value corresponds to an actuation command; and
actuating a bolt of the lock based on determining that the value corresponds to the actuation command.

2. The method of claim 1, further comprising:
after determining the position of the object:
determining an additional position of the object interacting with the touch interface;
determining an additional value that corresponds to the additional position;
determining that a sequence comprising the value and the additional value corresponds to an additional actuation command; and
actuating the bolt of the lock based on the sequence corresponding to the additional actuation command.

3. The method of claim 2, wherein the sequence is determined to correspond to the actuation command only when the value and the additional value are determined in a required order.

4. The method of claim 1, wherein the determining of the position of the object is based on the object interrupting at least one beam of the emitted infrared light, and the one or more infrared receivers detecting at least one reflected beam of the emitted infrared light.

5. The method of claim 1, wherein the one or more infrared emitters are operated simultaneously when determining the position of the object.

6. The method of claim 1, wherein the one or more infrared emitters are operated separately when determining the position of the object.

7. A computer readable storage medium comprising instructions which, when executed by a processor, cause the processor to:
cause one or more infrared emitters to emit infrared light;
detect the infrared light at one or more infrared receivers;
determine one or more positions of an object interacting with a touch interface of an infrared touchscreen based on the one or more infrared receivers detecting the infrared light;
determine one or more values that correspond to the one or more positions;
determine that the one or more values correspond to an actuation command; and
actuate a bolt of a lock based on determining that the one or more values correspond to the actuation command.

8. An electronic lock comprising:
an infrared touchscreen comprising:
a touch interface;
one or more infrared emitters; and
one or more infrared receivers;
a latch assembly comprising a bolt; and
a processing unit comprising:
a processor; and
a memory storing instructions which, when executed by the processor, cause the processor to:
cause at least a portion of the one or more infrared emitters to emit infrared light;
detect the infrared light at the one or more infrared receivers;
determine one or more positions of an object interacting with the touch interface based on the one or more infrared receivers detecting the infrared light;
determine one or more values that correspond to the one or more positions;
determine that the one or more values correspond to one of one or more actuation commands; and
actuate the bolt based on determining that the one or more values correspond to one of the one or more actuation commands.

9. The electronic lock of claim 8, further comprising a motor operable to actuate the bolt.

10. The electronic lock of claim 8, wherein the infrared touchscreen is operable to enter a low power mode.

11. The electronic lock of claim 10, wherein the memory stores additional instructions which, when executed by the processor and the infrared touchscreen is in the low power mode, cause the processor to:
cause a minimum portion of the one or more infrared emitters to emit infrared light;
determine which of the one or more infrared receivers detect received infrared light;
determine when the object interacts with the touch interface; and
cause the infrared touchscreen to exit the low power mode based on determining when the object interacts with the touch interface.

12. The electronic lock of claim 8, wherein the infrared touchscreen further comprises one or more buttons attached to the touch interface that indicate the value corresponding to a button position for a position of each button on the touch interface.

13. The electronic lock of claim 12, wherein the memory stores the one or more actuation commands.

14. The electronic lock of claim 8, further comprising a battery operable to supply power to the infrared touchscreen and the processing unit.

15. The electronic lock of claim 11, wherein the infrared touchscreen enters the low power mode when no object is detected for a duration of time.

16. The electronic lock of claim 8, wherein the one or more infrared emitters are positioned on a separate plane from the touch interface.

17. The electronic lock of claim 16, wherein the one or more positions of the object may be detected by the one or more infrared emitters distanced from a surface of the touch interface.

18. The electronic lock of claim 8, wherein the processing unit is configured to delay determining the position of the object interacting with the touch interface.

19. The electronic lock of claim 18, wherein the processing unit is further configured to delay determining the position of the object for approximately one second.

20. The electronic lock of claim 19, wherein the processing unit is further configured to skip the delay if the object is detected at a second position.
